(19) United States
(12) Patent Application Publication
(10) Pub. No.: US 2003/0089196 A1
(43) Pub. Date: May 15, 2003

(54) Clutch structure controlled by change of direction

(76) Inventor: Dong-Her Wu, Chang-Hua Hsien (TW)

Correspondence Address: Bruce H. Troxell, SUITE 1404, 5205, LEESBURG PIKE, FALLS CHURCH, VA, 22041, US

(21) Appl. No.: 09/987,065

(22) Filed: Nov. 13, 2001

(51) Int. Cl. F16H 37/00

(52) U.S. Cl. 74/665 F

(57) ABSTRACT

The present invention relates to a clutch structure controlled by change of direction, which is a driving gear protruded from the center of the plane of the driving disc, and provides a fixed cover with a set or a plurality of sets of curved lower restricted grooves at the bottom section of the axle gear, and the bottom of the driven gear disc is set to exactly fit the fixed cover gear, and it further works with the upper and lower limit groove in the interior and the engaged driven flywheel so that when each driven flywheel is rotated by the driving gear of the driving disc in the positive direction, the driven flywheel moves and drives the driven gear to circumrotate. When the driving disc rotates in the reverse direction, it will move away from the driven flywheel and run idly, which will stagnate the driven gear disc in order to attain the clutch effect of the driven gear by the control of rotations in positive and reverse directions of the driving disc.

### BACKGROUND OF THE INVENTION

1. Field of the Invention

The present invention relates to a clutch structure, which is controlled by change of direction, mainly provides a clutch with a set of driving discs for receiving a force from any dynamic source and a position restrictor connected to a gear on the upper section of the driving disc. Such simple components are assembled to form the clutch device of the present invention; wherein a gear axle is protruded from the center of the plane of the driving disc and the bottom of the driven gear is fixed and covered in a sealed gear having a set or a plurality of sets of restricting grooves to restrict the displacement. The driving gear engages into the passive flywheel that can provides a rotation in the positive direction to the driving disc, and thus moves the passive flywheel to engage and embedded by a set of blocking gears. It further drives the driven gear disk to circumrotate, or when the active disk rotates in reverse direction, the driving gear drives the driven flywheel in positive direction to move the lateral side of the curved position-restricting groove from the restricted position and separate the engagement with the latched blocking gear and it results in an idle running, and thus stagnates the driven gear disk. Such arrangement attains the clutch effect of the driven gear disc.

2. Description of the Prior Art

In general, the application of the traditional driving structure mainly uses a driving mechanical force source as an increase in sheathing another layer of the driven gear or the driven disc, etc. With different number of teeth or the adjustment of ratio of external diameter, it can only perform synchronization, and drive the lower section with different torque or the output control of the rotary speed, or by the design of increasing the one-way ratchet, the driven gear or driven disc will be in idle running when the driving gear rotates in the reverse direction. But, in fact it usually happens in many structural design and actual operation that the driven disc has specific timing (or position) and such function is a user-defined function. For example:

A regular massage mechanism with a chair cushion or a bed cushion has a requirement to massage a wild range of the entire back, and it has to come with a set of driving devices with another driving structural design that has continuous vibrations or rubbing movements and the back and forth movements in vertical direction of the back. The prior-art device of this sort uses the dual axles or dual driving complex form for the driving massage device and the back and forth carrying device for the massage movement control, the continual and the intermittent displacement or staying at a fixed point, and the adjustment in change of the back and forth movement of the massage position. Since such structure involves a complicated driving structure that has the carrying dynamic source (such as a motor) with dual axle rotation and the circuit control. It will increase the cost and occupy spaces, so that it has its own difficulty on manufacture and application, and is definitely not practical.

In view of the shortcomings of the prior art mentioned above, the inventor of the present invention based on years of experience accumulated from the engagement in the related industry conducted extensive research to resolve the foregoing shortcomings and invented the clutch structure of the present invention.

Therefore, the primary objective of the present invention is to provide a clutch structure simply controlled by the change in direction of the driving force of the driving disc or by the selection of the timing for the different operations of the driven gear disc such as its rotation or idle running, and more particularly it attains the simple clutch effect of the intermittent or continual rotation. Particularly, it does not need extra dynamic source, but has the multiple benefits of simple mechanism, easy manufacture and low cost.

The secondary objective of the present invention is to provide a clutch structure with different driving method by providing a dynamic source for the driving disc that can be directly coupled to a manual or motored, or indirectly to the chain and screw rod in order to have appropriate implementation of all kinds of sports, gymnastic exercises, or the clutch control application on other driving purposes, which is practical in a wide range of applications.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a three-dimensional diagram showing the disassembled parts of the present invention.

FIG. 2 is a three-dimensional diagram showing the assembled structure of a massage mechanism according to a preferred embodiment of the present invention.

FIG. 3 is a planar diagram showing the displacement of the massage components driven and carried by the driven gear disc of FIG. 2 according to a preferred embodiment of the present invention.

FIG. 3A is a partially enlarged diagram of the engagement status of the driven gear disc.

FIG. 4 is a planar diagram showing the massage components being separated from the engagement of the driven gear disc as in FIG. 2 and idled such that the massage components stop the displacement according to a preferred embodiment of the present invention.

FIG. 4A is a partially enlarged diagram of the driven gear disc being separated from the engagement status.

### DETAILED DESCRIPTION OF THE PREFERRED EMBODIMENT

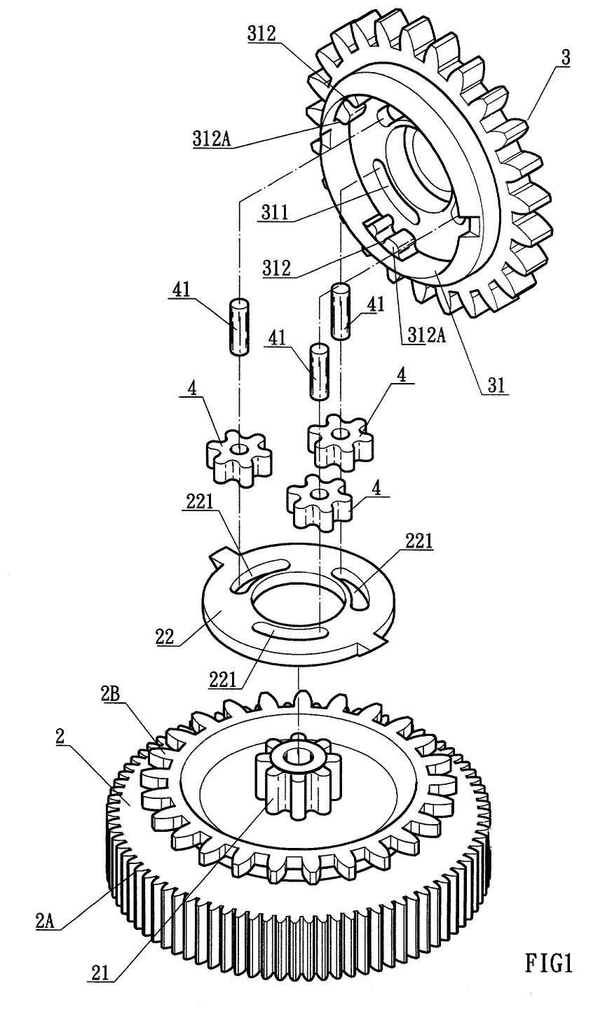

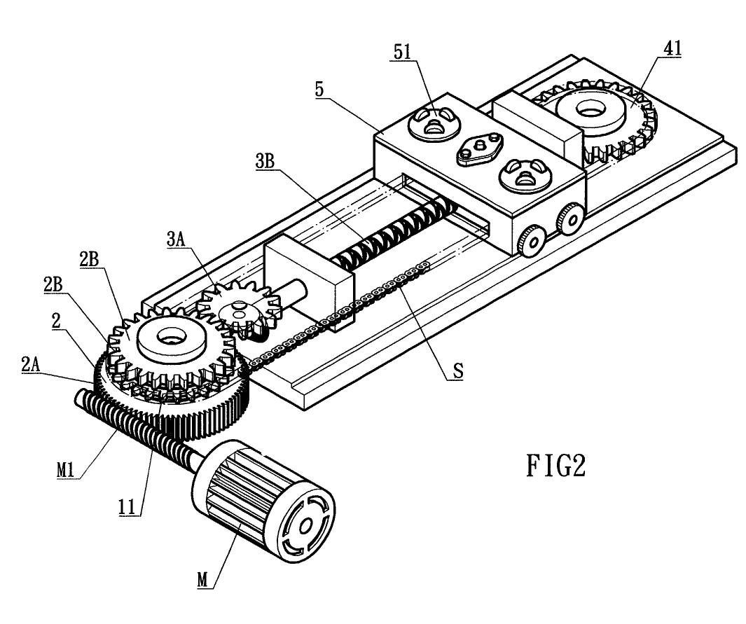

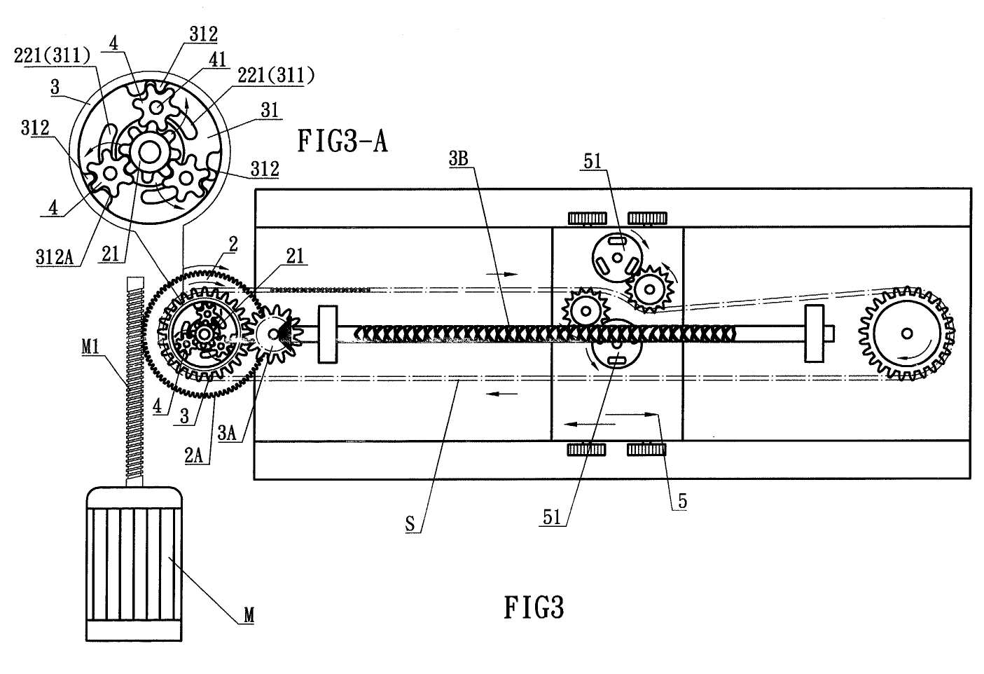

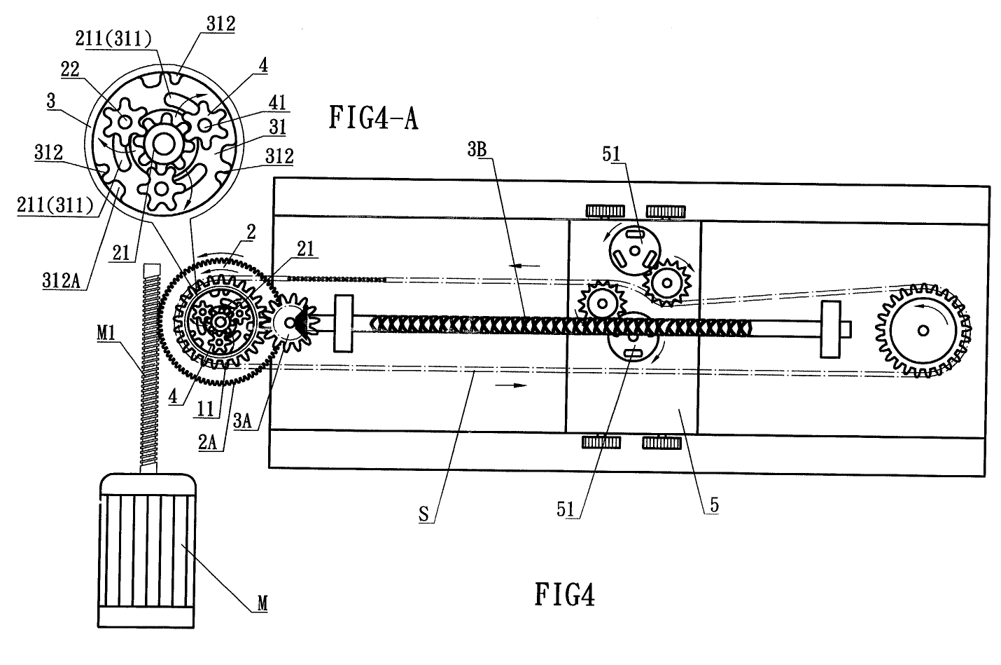

Please refer to FIG. 1, FIG. 2, FIG. 3A, and FIG. 3B. The clutch structure of the present invention mainly comprises a driving disc 2, and a restricted position sheathe coupled to the driven gear disc 3 at its upper section; characterized in that:

A driving gear axle 21 is protruded from the center of the plane surface of the driving disc 2, having a fixed cover 22 with a set or a plurality of curved lower limit groove 221 being sheathed to the bottom section of the gear axle 21; wherein the bottom of the driven gear disc 3 has an upper limit groove 31 with corresponding shapes and positions. Such arrangement provides an upper and lower limit positioning grooves 311, 221 and a bolt 41 is installed into each of them for the positioning. It forms a protruded axle on both ends for accommodating the curve displacement in curve, and distributes in the appropriate position on the rim of the driving gear axle 21 and properly engages the driven flywheel 4.

Furthermore, a latched blocking gear 312, each of which has a gear low in the front and high at the rear, is disposed at a limit position on the position-restricting groove 311; wherein the driven flywheel 4 also has a single body structure with protruded axle at both ends. It can save the process of installing an additional bolt 41, and the combination of the serrate engagement of the driving gear 21, driven flywheel 4 and latched blocking gear 312. It can also be substituted by the combination of frictional roller gears or frictional sliding members having the equivalent effect, which can also attain the same effect for the clutching or driving the driven gear disc.

By such structure (as shown in FIG. 3A), when each of the driven flywheel 4 is rotated in positive direction by the driving disc 2, the transmission engagement of the driving gear axle 21 will drive the driven flywheel 4 to rotate in the reverse direction, and displace along the latched blocking gear 312 to the limit position on the lateral side of the curved limit positioning grooves 311, 221, and enters into a further serrate engagement of the latched blocking gear 312. It immediately forms an embedded positioning by the blocking of the high blocking section 312A from the rear, and further drives the outer driven gear disc to circumrotate as shown in FIG. 3A. When the driving disc 2 rotates in the reverse direction, the driving gear axle 21 drives the driven flywheel 4 to rotate in the positive direction, and separate itself from the limit position of the curve limit-positioning grooves 311, 221, and separates itself from the serrate coupling of the latched blocking gear 312 and runs idly. It makes the driven gear disc 3 to stagnate or stop since it is separated from the transmission mechanism.

Such arrangement can control the driving disc at the bottom section to rotate in the positive and reverse directions by the driven gear disc 3, and can have the clutch and driving effect by the rotation or idle running of the driven gear disc 3 sheathed at the upper section.

As shown in FIG. 1, the driving disc 2 is disposed at the outer periphery (or a position at he disc surface on another side) of sheathing position of the driving gear axle 21 and the driving gear disc 3. A set (or a plurality of sets) of the coaxial axle which is the driving gear disc 2B having the synchronous rotation with the driving disc 2. Such arrangement forms a driving disc 2 of the same dynamic source, and at the same time operates a set or a multiple of sets of gear for the driving and driven operations, but one of the set has the dynamic source via the driven gear disc 3 for the rotations in positive and reverse directions to control the change in selection of rotation and idle running.

For the application of the aforementioned clutch and driving mechanism, the following embodiment of a prior-art massage structure (not the claimed structure of the present invention) is used for explanation.

Please refer to FIG. 2 and FIG. 3 which show a screw rod M1 is screwed onto the lateral gear surface 2A, and the driving disc 2 which uses a motor M as the dynamic source, and a driving gear disc 2B at its upper section is driven in cycle by the chain S to drive a set of massage disc 51 of the massage device 5 to continuously rotate in positive direction and reverse direction for the massage operation. The driven disc 3 drives a two-way screw rod 3B by the transmission of the transmission gear series 3A such that the rotation of the screw rod 3B will bring the main base of the massage device 5 to displace up and down vertically, and it attains the setting and control of the massage position.

Of course, the massage disc 51 is in continual circumrotation, and it works both in positive direction and reverse direction. Therefore, the continual rotation of the driving gear disc 2B will provide the need for the dynamic force, and the massage position has the requirement for rising, dropping, or remaining at a fixed point. Therefore, the setting (switching) of the positive rotation or the reverse rotation used in the motor M can be set to the positive direction by change of direction in order to drive the driven gear disc 3 and then rotate the two-way screw rod 3B such that it carries the massage device 5 to rise continuously or drop (when it rises or drops to the limit position, it will automatically reverse the direction by the action on the two-way screw rod). As the massage moves to the desired position, then the rotary direction of the motor M is switched to the reverse direction. Then, the driven gear disk 3 will be separated from the serrate engagement and fall into an idle status. The two-way screw rod 3B will stop its rotation, such that the massage device 5 will stay in a certain position, but the massage disc 51 will continue since it is carried by the rotation of the driving gear disc 2B and the chain S for the circumrotation.

Therefore, in summation of the above description, we are able to see the application and operation of each item of the present invention, which meets the requirements of patentability, which is hereby submitted for patent application. While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

| | |
|---|---|
| Driving Disc: 2 | Driving Gear Axle: 21 |
| Fixed Cover: 22 | Lower Limit Groove: 211 |
| Side Gear Surface: 2A | Driving Gear Disc: 2B |
| Driven Gear Disc: 3 | Gear Groove: 31 |
| Upper Limit Groove: 311 | Engaged Blocking Teeth: 312 |
| Blocking Section: 312A | Transmission Gear Series: 3A |
| Two-way Screw Rod: 3B | Driven Flywheel: 4 |
| Bolt: 41 | Massage Device: 5 |

What is claimed is:

1. A clutch structure controlled by change of direction, comprising a driving disc, and a restricted position sheathed to the driven gear disc at its upper section; characterized in that: a driving gear axle is protruded from the center of the plane surface of the driving disc, having a fixed cover with a set or a plurality of sets of curved lower limit groove being sheathed to the bottom section of the gear axle; wherein the bottom of the driven gear disc has an upper limit groove with corresponding shapes and positions, and such arrangement provides an upper and lower limit positioning grooves, and a bolt is installed into each of them for the positioning; it forms a protruded axle on both ends for accommodating the curve displacement in positioning, and is distributed in the appropriate position on the outer periphery of the driving gear axle and properly engages the driven flywheel; a latched blocking gear each of which has a gear low in the front and high at the rear, is disposed at a limit position on the position-restricting groove; causing the driven flywheel to rotate in reverse direction, and moves into the curve limit position of the of curve limit position groove, and enters into the latched blocking gear, and immediately forms an embedded positioning by the blocking of the high blocking section, and further drives the outer driven gear disc to circumrotate; as the driving disc rotates in the reverse direction, the driving gear axle drives the driven flywheel to rotate in the positive direction, and separate itself from the limit position of the curve limit-positioning grooves, and from the serrate coupling of the latched blocking gear for the idle running, and it also makes the driven gear disc to stagnate and stop that can control the driving disc at the bottom section to rotate in the positive and reverse directions by the driven gear disc, and can have the clutch and driving effect by the rotation or idle running of the driven gear disc 3 sheathed at the upper section.

2. A clutch structure controlled by change of direction as claimed in claim 1, wherein said driving disc could be a gear, belt disc, or any other that accepts dynamic source which can provide the circumrotation transmission in positive and reverse directions for attaining the effect of controlling the clutch of the driving disc.

3. A clutch structure controlled by change of direction as claimed in claim 1, wherein said driving disc can have an additional set of a plurality of sets of the coaxial axle at the periphery where the driving gear and the transmission gear are coupled or at the other side of the disc surface, and the driving disc synchronously drives the driving gear disc, such that it forms the same dynamic source of the driving disc to simultaneously operate a set or a plurality of sets of gears for the driving and driven operations, wherein one of the sets has the effect for selecting the rotation for the dynamic source in positive direction, reverse direction, or in idle running.

4. A clutch structure controlled by change of direction as claimed in claim 1, wherein said driving gear axle, driven flywheel with the latched blocking gear are coupled with serrate engagement, and such serrate engagement can be substituted by the frictional roller combination with the equivalent effect or frictional slippery member to give equivalent effect for the clutch or driving effect for the driven gear disc.

5. A clutch structure controlled by change of direction as claimed in claim 1, wherein said driven flywheel can be set as a single member that haves a protruded axle on each of its ends to substitute the insertion of the bolt.
